(19) United States
(12) Patent Application Publication
(10) Pub. No.: US 2023/0048078 A1
(43) Pub. Date: Feb. 16, 2023

(54) SCREW WITH MULTIPLE THREAD ANGLES

(71) Applicant: TAIWAN SHAN YIN INTERNATIONAL CO., LTD., KAOHSIUNG CITY (TW)

(72) Inventors: KOU-TSAIR SU, KAOHSIUNG CITY (TW); CHEN-LONG SU, KAOHSIUNG CITY (TW)

(21) Appl. No.: 17/399,416

(22) Filed: Aug. 11, 2021

(51) Int. Cl. F16B 25/00

(52) U.S. Cl. CPC F16B 25/0073; F16B 25/0052

(57) ABSTRACT

A screw with multiple thread angles includes a shank, a main threaded portion having thread convolutions, and a head. Each thread convolution defines different thread angles from a root to a thread crest in sequence, namely a first thread angle ranging between 70 degrees and 75 degrees, a second thread angle ranging between 37 degrees and 43 degrees, and a third thread angle ranging between 20 degrees and 23 degrees. Notches are recessed into the thread crest for attaining a smooth removal of cut chips. The third thread angle assists each thread convolution in cutting a workpiece sharply to facilitate a quick cutting operation. The second thread angle and the first thread angle help widen a cutting track caused by the cutting operation gradually so that the thread convolutions are continuously drilled into the workpiece by a multi-stage reaming and drilling operation to achieve a quick screwing effect.

### BACKGROUND OF THE INVENTION

### 1. Field of the Invention

This invention relates to a screw and relates particularly to a screw with multiple thread angles.

### 2. Description of the Related Art

Referring to FIG. 1 and FIG. 1A, a conventional screw 1 comprises ahead 11, a shank 12 extending outwards from the head 11, and a threaded portion 13 spirally disposed on the shank 12. The threaded portion 13 has a plurality of thread convolutions 13a spirally formed on the shank 12. Each thread convolution 13a has a root 130 connected to the shank 12, an upper thread flank 131 extending outwards from the root 130, a lower thread flank 132 extending outwards from the root 130 and connected to the upper thread flank 131, and a thread crest 133 formed along a junction of the upper thread flank 131 and the lower thread flank 132. During a screwing operation, the head 11 receives a rotational force in order that the thread convolutions 13a cut into a workpiece (not shown) and synchronously screws the shank 12 into the workpiece gradually whereby the screwing operation is completed.

However, the thread convolutions 13a share an equal thread angle 13α defined between the upper thread flank 131 and the lower thread flank 132. When the thread angle 13α is adjusted to be large, the sharpness of the thread convolutions 13a is reduced, namely the thread convolutions 13a are unable to cut the workpiece sharply. Meanwhile, a contact area between each thread convolution 13a and the workpiece is increased, and that will increase the friction caused when the thread convolutions 13a cut into the workpiece. Cut chips generated during the screwing operation will accumulate easily and cannot be excluded outwards smoothly, and that will increase the screwing resistance and the screwing torque. Thus, larger rotational force should be adapted to screw the screw 1 into the workpiece during the screwing operation. The screwing speed is also reduced. Further, the accumulated cut chips may entangle around the shank 12 to cause that the screwing resistance is increased. The accumulated cut chips will press each other to also enlarge the screwing resistance, and that requires to be improved.

When the thread angle 13α is adjusted to be small, the sharpness of the thread convolutions 13a is increased, but the thread convolutions 13a cannot provide enough support for engaging with workpiece. Thus, the screw 1 cannot be engaged with the workpiece tightly after screwing into the workpiece. A screwing positioning effect is poor, and that requires to be improved.

### SUMMARY OF THE INVENTION

The object of this invention is to provide a screw with multiple thread angles capable of reducing screwing resistance, excluding cut chips smoothly, and achieving a quick screwing effect.

The screw with multiple thread angles of this invention comprises a head, a shank extending outwards from the head, and a main threaded portion spirally formed on the shank. The main threaded portion has a plurality of thread convolutions spirally disposed on the shank. Each thread convolution has a root connected to the shank, an upper thread flank extending outwards from the root, a lower thread flank extending outwards from the root and connected to the upper thread flank, a thread crest formed along a junction of the upper thread flank and the lower thread flank, opposite first upper and lower flank sections extending from the root and respectively defined on the upper thread flank and the lower thread flank, opposite second upper and lower flank sections extending from the first upper and lower flank sections respectively, and opposite third upper and lower flank sections extending from the second upper and lower flank sections to the thread crest respectively. A first thread angle is defined between the first upper flank section and the first lower flank section and ranges from 70 degrees to 75 degrees. A second thread angle is defined between the second upper flank section and the second lower flank section and ranges from 37 degrees to 43 degrees. A third thread angle is defined between the third upper flank section and the third lower flank section and ranges from 20 degrees to 23 degrees. A plurality of notches is recessed into the thread crest. Each notch has a chip-guiding surface cut into the thread crest, an upper cutting edge formed along a junction of the chip-guiding surface and the upper thread flank, and a lower cutting edge formed along a junction of the chip-guiding surface and the lower thread flank. Hence, the third thread angle assists each thread convolution in cutting a workpiece sharply to accelerate a cutting operation. The first and second thread angles help enlarge a cutting track caused by the cutting operation gradually so that the thread convolutions are continuously drilled into the workpiece by a multi-stage reaming and drilling operation to achieve a quick screwing effect. Thus, the friction caused when the screw screws into the workpiece is reduced. The thread convolutions are sharpened effectively. The screwing resistance is reduced. Further, the notches can help exclude cut chips smoothly to attain a smooth removal of the cut chips.

Preferably, the first upper and lower flank sections extend by a first length. The second upper and lower flank sections extend by a second length. The third upper and lower flank sections extend by a third length. The first length is equal to both of the second length and the third length.

Preferably, an auxiliary threaded portion is spirally disposed on the shank.

Preferably, a bottom of the chip-guiding surface is in contact with the second upper and lower flank sections.

### BRIEF DESCRIPTION OF THE DRAWINGS

FIG. 1 is a schematic view showing a conventional screw;

FIG. 1A is an enlarged view of the encircled portion 1A indicated in FIG. 1;

FIG. 2 is a schematic view showing a first preferred embodiment of this invention;

FIG. 2A is an enlarged view of the encircled portion 2A indicated in FIG. 2;

FIG. 3 is a cross-sectional view showing the thread convolution as seen along the line S-S of FIG. 2;

FIG. 4 is an enlarged view showing a partial element of FIG. 2; and

FIG. 5 is a schematic view showing a second preferred embodiment of this invention characterized by an auxiliary threaded portion.

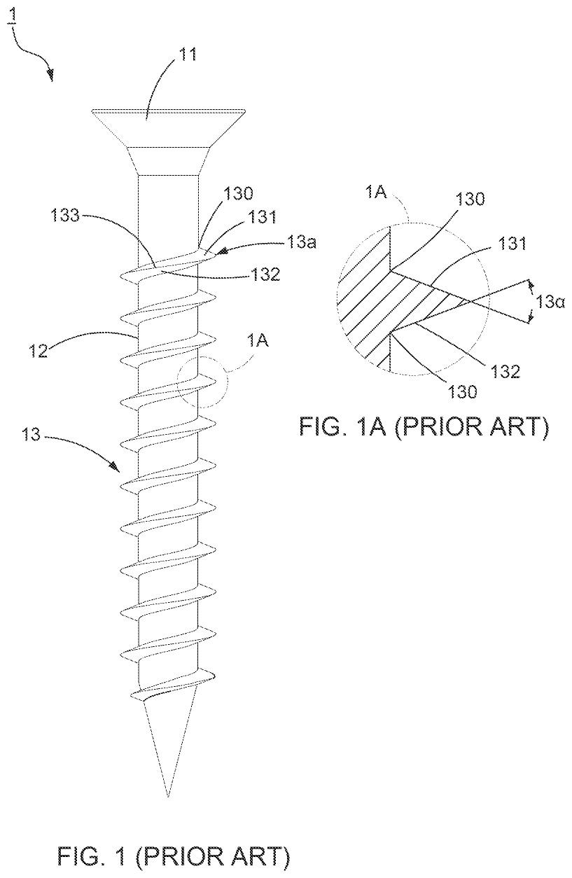

### DETAILED DESCRIPTION OF THE PREFERRED EMBODIMENTS

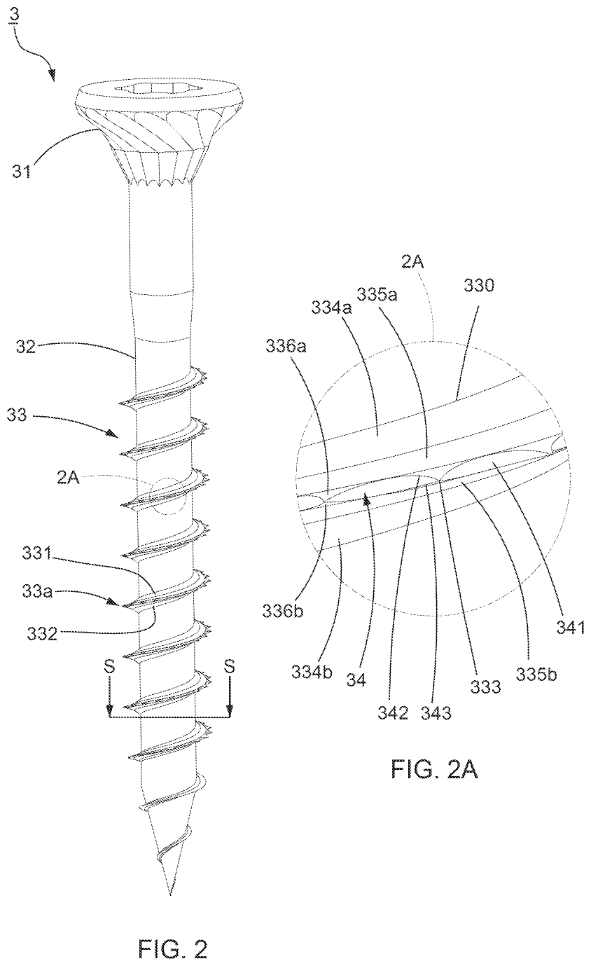

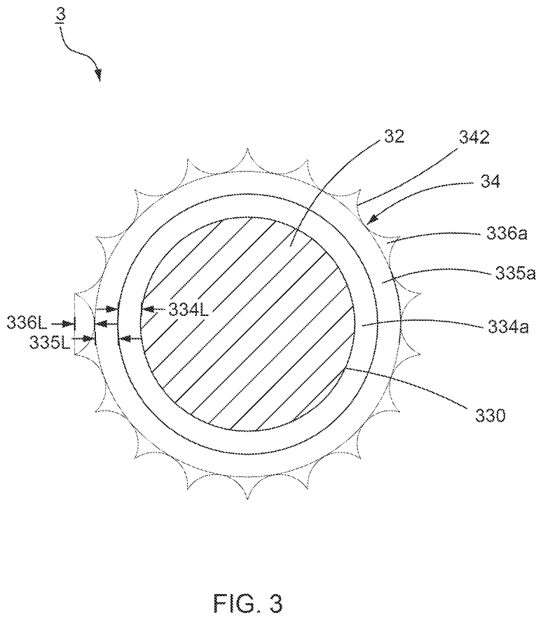

Referring to FIGS. 2 and 2A, a first preferred embodiment of a screw 3 with multiple thread angles of this invention is disclosed. The screw 3 includes a head 31, a shank 32 extending outwards from the head 31, a main threaded portion 33 spirally disposed on the shank 32, and a plurality of notches 34 formed on the main threaded portion 33. The main threaded portion 33 has a plurality of thread convolutions 33a spirally formed on the shank 32. Each thread convolution 33a has a root 330 connected to the shank 32, an upper thread flank 331 extending outwards from the root 330, a lower thread flank 332 extending outwards from the root 330 and connected to the upper thread flank 331, a thread crest 333 formed along a junction of the upper thread flank 331 and the lower thread flank 332, opposite first upper flank section 334a and first lower flank section 334b extending from the root 330 and respectively defined on the upper thread flank 331 and the lower thread flank 332, opposite second upper flank section 335a and second lower flank section 335b extending from the first upper flank section 334a and the first lower flank section 334b respectively, and opposite third upper flank section 336a and third lower flank section 336b extending from the second upper flank section 335a and the second lower flank section 335b to the thread crest 333 respectively. Referring to FIGS. 2A and 3, in this preferred embodiment, the first upper flank section 334a and the first lower flank section 334b extend by a first length 334L. The second upper flank section 335a and the second lower flank section 335b extend by a second length 335L. The third upper flank section 336a and the third lower flank section 336b extend by a third length 336L. The first length 334L is equal to both of the second length 335L and the third length 336L.

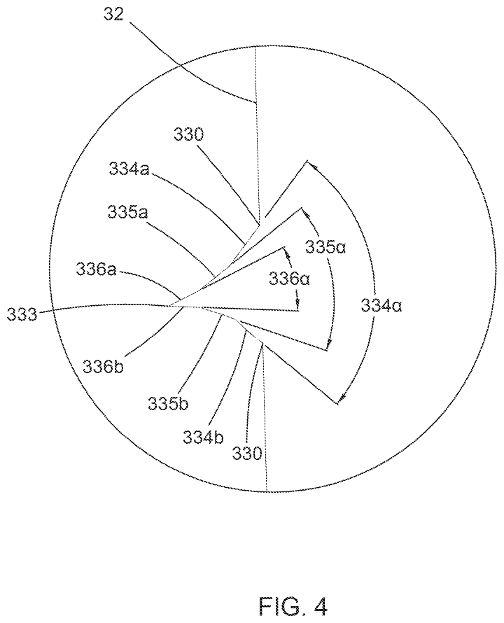

Referring to FIG. 4, a first thread angle 334a is defined between the first upper flank section 334a and the first lower flank section 334b and ranges from 70 degrees to 75 degrees. A second thread angle 335a is defined between the second upper flank section 335a and the second lower flank section 335b and ranges from 37 degrees to 43 degrees. A third thread angle 336a is defined between the third upper flank section 336a and the third lower flank section 336b and ranges from 20 degrees to 23 degrees. Each notch 34 has a chip-guiding surface 341 recessed into the thread crest 333 to the third upper flank section 336a and the third lower flank section 336b, an upper cutting edge 342 formed along a junction of the chip-guiding surface 341 and the upper thread flank 331, and a lower cutting edge 342 formed along a junction of the chip-guiding surface 341 and the lower thread flank 332. In this preferred embodiment, a bottom of the chip-guiding surface 341 is in contact with the second upper flank section 335a and the second lower flank section. 335b as shown in FIG. 3.

Referring to FIGS. 2, 2A and 4, a screwing operation of the screw 3 begins with positioning an end of the screw 3 against a surface of a workpiece (not shown). Then, the head 31 receives a rotational force in order to carry out a cutting operation of the thread convolutions 33a and allow the screw 3 to enter into the workpiece gradually. Because the third thread angle 336a ranging between 20 degrees and 23 degrees is smaller than the first thread angle 334a and the second thread angle 335a, it sharpens the thread crest 333 whereby the cutting performance of the screw 3 is improved and the cutting operation is accelerated. The thread convolutions 33a can cut the workpiece sharply and quickly to further screw the shank 32 into the workpiece smoothly. Meanwhile, the notches 34 formed on the thread convolutions 33a facilitate a smooth removal of cut chips. The cut chips generated during the cutting operation can be excluded outwards smoothly through the chip-guiding surface 341 of each notch 34 to thereby prevent the cut chips from being accumulated in the workpiece and prevent the screwing resistance from increasing caused by the accumulated cut chips. Simultaneously, the upper cutting edge 342 and the lower cutting edge 343 respectively formed along a junction of the chip-guiding surface 341 and the upper and lower thread flanks 331, 332 can also assist in cutting the workpiece to thereby break fibers of the cut chips effectively and prevent the shank 32 from being entangled by the fibers of the cut chips. Thus, the main threaded portion 33 can screw into the workpiece easily. Besides, the second thread angle 335a ranging between 37 degrees and 43 degrees can support the first upper flank section 334a and the first lower flank section 334b duly and reduce a contact area between the thread convolutions 33a and the workpiece to thereby reduce the screwing resistance and increase the screwing speed. Meanwhile, the first thread angle 334α ranging between 70 degrees and 75 degrees assists in increasing the strength of the thread convolutions 33a so that the thread convolutions 33a can bear larger screwing force to further prevent the thread convolutions 33a from being deformed or damaged during the screwing operation. The first thread angle 334α also facilitates a tight engagement between the thread convolutions 33a and the workpiece after the screw 3 screws into the workpiece to thereby attain the effect of stable screwing. Further, each thread convolution 33a is narrowed gradually from the root 330 to the thread crest 333 in sequence to further define the first thread angle 334α, the second thread angle 335α, and the third thread angle 336α, and that widens a cutting track caused by the cutting operation gradually so that the thread convolutions 33a are continuously and smoothly drilled into the workpiece by a multi-stage reaming and drilling operation to achieve a quick screwing effect and reduce the screwing resistance. Hence, the arrangement of the third thread angle 336α, the second thread angle 335α, and the first thread angle 334α sharpens each thread convolution 33a, facilitates the quick cutting operation, reduces the screwing resistance, and attains the tight engagement between the thread convolutions 33a and the workpiece. The notches 34 recessed into the thread crest 333 can assist in attaining a smooth removal of the cut chips.

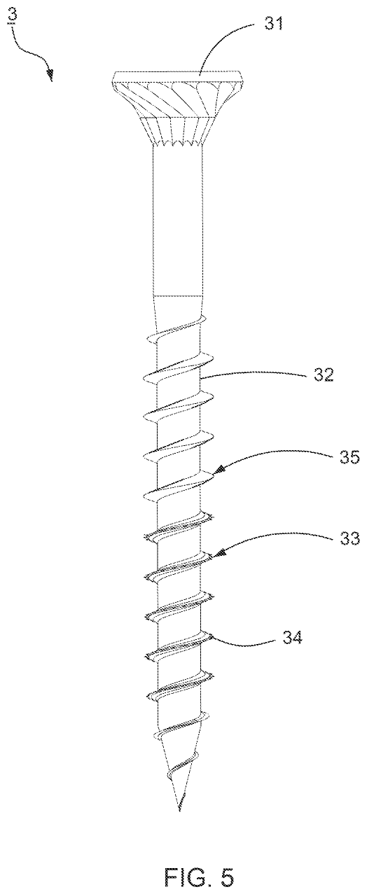

Referring to FIG. 5 shows a second preferred embodiment of the screw 3 of this invention. The correlated elements and the concatenation of elements, the operation and objectives of the second preferred embodiment are the same as those of the first preferred embodiment. This embodiment is characterized in that an auxiliary threaded portion 35 is spirally disposed on the shank 32. Thus, the auxiliary threaded portion 35 can not only help cut the workpiece, but also enhance the tight engagement between the screw 3 and the workpiece after the screw 3 screws into the workpiece.

To sum up, the screw with multiple thread angles of this invention takes an advantage that each thread convolution defines different thread angles from the root to the thread crest in sequence, namely the first thread angle ranging between 70 degrees and 75 degrees, the second thread angle ranging between 37 degrees and 43 degrees, and the third thread angle ranging between 20 degrees and 23 degrees to increase the sharpness of the thread convolutions, facilitate the quick cutting operation, reduce the screwing resistance, and achieve the quick screwing effect. Further, the notches cut into the thread crest help exclude the cut chips outwards smoothly and quickly to thereby prevent the cut chips from being accumulated.

While the embodiments of this invention are shown and described, it is understood that further variations and modifications may be made without departing from the scope of this invention.

What is claimed is:

1. A screw with multiple thread angles comprising:
a head;
a shank extending outwards from said head; and
a main threaded portion having a plurality of thread convolutions spirally disposed on said shank, wherein each of said plurality of thread convolutions of said main threaded portion includes a root connected to said shank, an upper thread flank extending outwards from said root, a lower thread flank extending outwards from said root and connected to said upper thread flank, and a thread crest formed along a junction of said upper thread flank and said lower thread flank;
wherein each of said plurality of thread convolutions includes opposite first upper and lower flank sections extending from said root and respectively defined on said upper thread flank and said lower thread flank, opposite second upper and lower flank sections extending from said first upper and lower flank sections respectively, and opposite third upper and lower flank sections extending from said second upper and lower flank sections to said thread crest respectively, a first thread angle being defined between said first upper flank section and said first lower flank section and ranging from 70 degrees to 75 degrees, a second thread angle being defined between said second upper flank section and said second lower flank section and ranging from 37 degrees to 43 degrees, a third thread angle being defined between said third upper flank section and said third lower flank section and ranging from 20 degrees to 23 degrees, a plurality of notches being cut into said thread crest, each of said plurality of notches including a chip-guiding surface recessed into said thread crest, an upper cutting edge formed along a junction of said chip-guiding surface and said upper thread flank, and a lower cutting edge formed along a junction of said chip-guiding surface and said lower thread flank.

2. The screw according to claim 1, wherein said first upper and lower flank sections extend by a first length, said second upper and lower flank sections extending by a second length, said third upper and lower flank sections extending by a third length, said first length being equal to both of said second length and said third length.

3. The screw according to claim 1, wherein an auxiliary threaded portion is spirally disposed on said shank.

4. The screw according to claim 2, wherein an auxiliary threaded portion is spirally disposed on said shank.

5. The screw according to claim 1, wherein a bottom of said chip-guiding surface is in contact with said second upper and lower flank sections.

6. The screw according to claim 2, wherein a bottom of said chip-guiding surface is in contact with said second upper and lower flank sections.
